(19) United States
(12) Patent Application Publication
(10) Pub. No.: US 2018/0300134 A1
(43) Pub. Date: Oct. 18, 2018

(54) SYSTEM AND METHOD OF EXECUTING CACHE LINE UNALIGNED LOAD INSTRUCTIONS

(71) Applicant: Shanghai Zhaoxin Semiconductor Co., Ltd., Shanghai (CN)

(72) Inventor: Qianli DI, Beijing (CN)

(21) Appl. No.: 15/810,798

(22) Filed: Nov. 13, 2017

(30) Foreign Application Priority Data
Apr. 18, 2017 (CN) 201710252121.9

(51) Int. Cl. G06F 9/30; G06F 12/0875

(52) U.S. Cl. CPC G06F 9/30043; G06F 9/3836; G06F 12/0875

(57) ABSTRACT

A processor that is capable of executing cache line unaligned load instructions includes a scheduler, a memory execution unit, and a merge unit. When the memory execution unit detects an unaligned load dispatched by the scheduler, it stalls the scheduler and inserts a second load instruction into the memory execution unit after the unaligned load instruction. Execution of the unaligned load returns first partial data from a first cache line, and execution of the second load instruction returns second partial data from the next sequential cache line. The merge unit merges the partial data to provide result data to the next pipeline stage. The scheduler may be stalled for only one cycle sufficient to insert the second load instruction just after the unaligned load instruction.

### CROSS REFERENCE TO RELATED APPLICATIONS

This application claims the benefit of China Patent Application No. 201710252121.9, filed on Apr. 18, 2017, the entirety of which is incorporated by reference herein.

### BACKGROUND OF THE INVENTION

### Field of the Invention

The present invention relates in general to the process of executing load instructions to load information from memory in a processor, and more particularly to a system and method of executing cache line unaligned load instructions to load data that crosses a cache line boundary.

### Description of the Related Art

Computer programs include instructions to perform the functions of the program including load instructions to read data from memory. A typical computer system includes a processor for executing the instructions, and an external system memory coupled to the processor for storing portions of the computer program and applicable data and information. The term “processor” as used herein refers to any type of processing unit, including a microprocessor, a central processing unit (CPU), one or more processing cores, a microcontroller, etc. The term “processor” as used herein also includes any type of processor configuration, such as processing units integrated on a chip or integrated circuit (IC) including those incorporated within a system on a chip (SOC) or the like.

Loading data from the system memory consumes valuable processing time, so the processor typically includes a smaller and significantly faster cache memory for loading data for processing. At least a portion of the cache memory is typically incorporated within the processor for faster access. Some cache memory may be externally located, but if so is usually connected via a separate and/or dedicated cache bus to achieve higher performance. Blocks of data may be copied into the cache memory at a time, and the processor operates faster and more efficiently when operating from the cache memory rather than the larger and slower external system memory. The cache memory is organized as a sequential series of cache lines, in which each cache line typically has a predetermined length. A common cache line size, for example, is 64 bytes although alternative cache line sizes are contemplated.

A computer program may execute one or more load instructions to load a specified amount of data from a particular memory location in the cache memory. Each load instruction may include a load address and a data length. The load address specified in the software program, however, may not necessarily be the same physical address used by the processor to access the cache memory. Modern processors, including those based on the x86 instruction set architecture, may perform address translation including segmentation and paging and the like, in which the load address is transformed into an entirely different physical address for accessing the cache memory. Furthermore, one or more of the load instructions may not directly align with the cache line size. As a result, the memory read operation may attempt to load data that crosses a cache line boundary, meaning that the specified data starts on one cache line and ends on the next cache line. Since the target data occupies more than one cache line, this type of memory read operation is known as a cache line unaligned load. A special method is usually required to handle the cache line unaligned load operations because the data is not retrievable using a single normal load request. Modern processors typically use a popular cache structure in which only one cache line is accessible for a single load request, so that the cache line unaligned load operation must be handled in a different manner which negatively impacts performance.

Conventional solutions for handling cache line unaligned load operations have been inefficient and have consumed valuable processing time to eventually retrieve the correct data. Software programs and applications that caused a significant number of cache line unaligned load operations resulted in inefficient operation and reduced performance.

### SUMMARY OF THE INVENTION

A processor that is capable of executing cache line unaligned load instructions according to one embodiment includes a scheduler, a memory execution unit, and a merge unit. The scheduler dispatches a load instruction for execution. The memory execution unit executes the load instruction, and when the load instruction is determined to be a cache line unaligned load instruction, the memory execution unit stalls the scheduler, determines an incremented address to a next sequential cache line, inserts a copy of the cache line unaligned load instruction as a second load instruction using the incremented address at an input of the memory execution unit, and retrieves first data from a first cache line by executing the cache line unaligned load instruction. The memory execution unit executes the second load instruction to retrieve second data from the next sequential cache line. The merge unit merges first partial data of the first data with second partial data of the second data to provide result data.

The processor may adjust an address specified with the cache line unaligned load instruction to retrieve data from a first cache line. Such adjustment may be made using a specified data length and an address of the next sequential cache line. The second load instruction inserted after the cache line unaligned load may include the incremented address and the specified data length. The merge unit may append the first data to the second data to combine the first partial data with the second partial data to isolates the result data.

The memory execution unit may stall the scheduler for one cycle for inserting the second load instruction at the input of the memory execution unit. The second load instruction may be inserted immediately after the cache line unaligned load instruction. The memory execution unit may stall the scheduler from dispatching another load instruction and/or any instructions that depend on the cache line unaligned load instruction. The memory execution unit may restart the scheduler after inserting the second load instruction.

A method capable of executing of cache line unaligned load instructions according to one embodiment includes dispatching, by a scheduler, a load instruction for execution, determining whether the dispatched load instruction is a cache unaligned load instruction during execution, and when the dispatched load instruction is determined to be a cache unaligned load instruction, stalling a scheduler that dispatches instructions for execution, inserting a second load instruction for execution, in which the second load instruction is a copy of the cache unaligned load instruction except that it uses an incremented address to a next sequential cache line, retrieving first data from a first cache line as a result of executing the cache unaligned load instruction, retrieving second data from the next sequential cache line as a result of executing the second load instruction, and merging partial data of the first data with partial data of the second data to provide result data for the cache unaligned load instruction.

The method may include adjusting an address used with the cache unaligned load instruction based on a specified data length provided with the cache unaligned load instruction and the incremented address. The method may include appending the first data to the second data, and isolating and combining the first partial data of the first data and the second partial data of the second data to provide the result data. The method may include inserting the second load instruction as the next load instruction after the cache line unaligned load instruction. The method may include stalling the scheduler from dispatching another load instruction and/or any instructions that depend on the cache line unaligned load instruction. The method may include restarting the scheduler after inserting the second load instruction. The method may include storing at least one of the first and second data before merging the partial data.

### BRIEF DESCRIPTION OF THE DRAWINGS

The benefits, features, and advantages of the present invention will become better understood with regard to the following description, and accompanying drawings where:

FIG. 1 is a simplified block diagram of a superscalar, pipelined processor that executes a cache line unaligned load instruction according to one embodiment of the present invention;

FIG. 2 is a simplified diagram illustrating the result of the merge operation performed by the merge unit of FIG. 1 according to one embodiment of the present invention; and

FIG. 3 is a flowchart diagram illustrating stalling pipeline execution by the processor of FIG. 1 for executing a cache line unaligned load instructions according to an embodiment of the present invention.

### DETAILED DESCRIPTION

The inventor has recognized the inefficiencies and lower performance associated with executing cache line unaligned load instructions. He has therefore developed a system and method of stalling pipeline execution of a cache line unaligned load instruction, including immediately inserting the same load instruction with an incremented address to the next cache line into the pipeline, and merging the results.

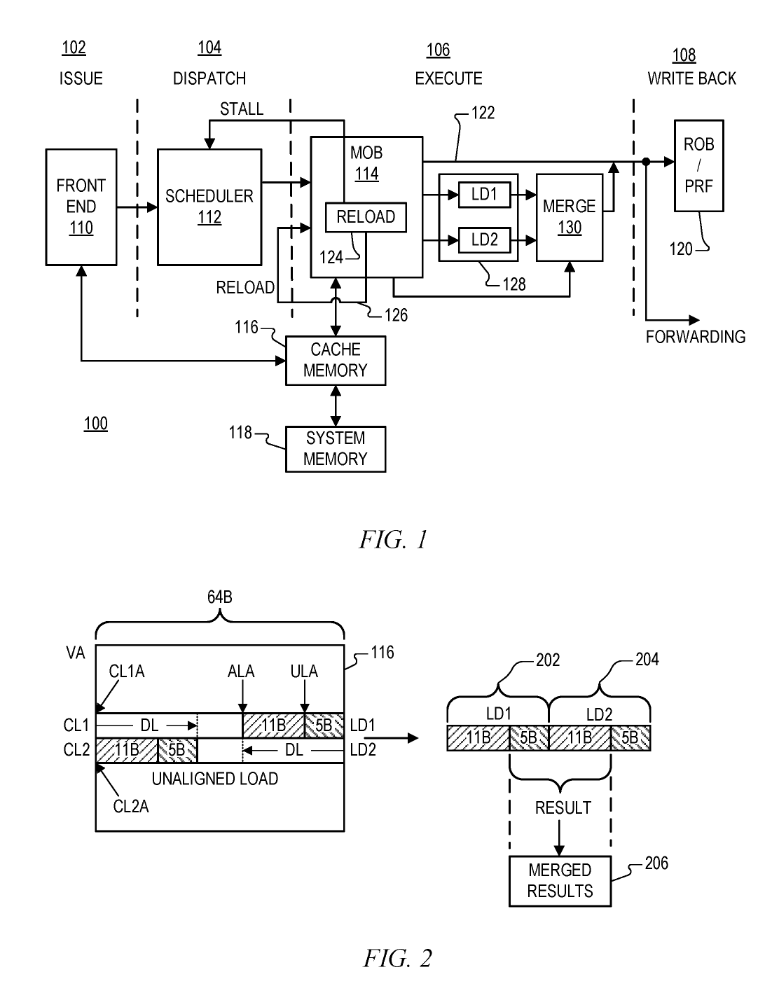

FIG. 1 is a simplified block diagram of a superscalar, pipelined processor 100 that executes a cache line unaligned load instruction according to one embodiment of the present invention. The macroarchitecture of the processor 100 may be an x86 macroarchitecture in which it can correctly execute a majority of the application programs that are designed to be executed on an x86 processor. An application program is correctly executed if its expected results are obtained. In particular, the processor 100 executes instructions of the x86 instruction set and includes the x86 user-visible register set. The present invention is not limited to x86 architectures, however, in which processor 100 may be according to any alternative architecture as known by those of ordinary skill in the art.

In the illustrated embodiment, the processor 100 has a pipelined architecture with multiple stages, including an issue stage 102, a dispatch stage 104, an execute stage 106, and a write back stage 108. The stages are shown separated by dashed lines each generally depicting a set of synchronous latches or the like for controlling timing based on one or more clock signals. The issue stage 102 includes a front end 110, which generally operates to retrieve cache lines from an application or program located in an external system memory 118, decode and translate the retrieved information into instructions, and issue the translated instructions to the dispatch stage 104 in program order. The front end 110 may include, for example, an instruction cache (not shown) that retrieves and stores cache lines incorporating program instructions, an instruction decoder and translator (not shown) that decodes and translates the cache lines from the instruction cache into instructions for execution, and a register alias table (RAT) (not shown) that generates dependency information for each instruction based on its program order, on the operand sources it specifies, and on renaming information.

In one embodiment, an application or software program stored in the system memory 118 incorporates macroinstructions of a macroinstruction set of the processor 100 (e.g., the x86 instruction set architecture). The system memory 118 is organized into cache lines of a certain size, such as 64 Bytes (64B) or the like. The system memory 118 is interfaced to the processor 100 via a cache memory 116, which may include multiple cache levels, such as a level-1 (L1) level-2 (L2) cache, a level-3 (L3) cache, etc. In one embodiment, the instruction cache within the front end 110 may be an L1 cache for retrieving cache lines from a program or application stored within the system memory 118, whereas the L1 cache in the cache memory 116 may store data loaded from, or for storing into, the system memory 118. The L2 cache within the cache memory 116 may be a unified cache for storing both instructions and data. The front end 110 parses or decodes the retrieved cache lines into the macroinstructions, and then translates the macroinstructions into microinstructions of a microinstruction set suitable for execution by the processor 100. The microinstructions are generally referred to herein as “instructions” that are executed by the processor 100.

The front end 110 issues the translated instructions and their associated dependency information to a scheduler 112 of the dispatch stage 104. The scheduler 112 includes one or more queues that hold the instructions and dependency information received from the RAT (in the front end 110, not shown). The scheduler 112 dispatches instructions to the execute stage 106 when ready to be executed. An instruction is ready to be executed when all of its dependencies are resolved and an execution unit is available to execute the instruction. Functional instructions, such as floating point instructions (e.g., media type instructions or the like) or integer instructions or the like, are dispatched to functional execution units (not shown). Memory instructions, including load and store instructions, are dispatched to a memory order buffer (MOB) 114. The MOB 114 includes one or more load and store pipelines, or combined load/store pipelines. The MOB 114 accesses the cache memory 116 which stores data and information loaded from the system memory 118 or otherwise to be ultimately stored into the system memory 118. The term “MOB” is a common lexicon for a memory execution unit that executes memory type instructions, including load and store instructions.

In conjunction with issuing an instruction, the RAT (in the front end 110, not shown) also allocates an entry for the instruction in a reorder buffer (ROB) 120, which is shown located in the write back stage 108. Thus, the instructions are allocated in program order into the ROB 120, which may be configured as a circular queue to ensure that the instructions are retired in program order. In certain configurations, the allocated entry within the ROB 120 may further include memory space, such as a register or the like, for storing the results of the instruction once executed. Alternatively, the processor 100 includes a separate physical register file (PRF), in which the allocated entry may include a pointer to an allocated register within the PRF for storing result information. A load instruction, for example, retrieves data from the cache memory 116 and temporarily stores the data into the allocated register in the PRF.

The MOB 114 receives load instructions and determines whether the load is cache line aligned or unaligned. Each load instruction includes a specified address and a specified data length. The MOB 114 translates the address of the load instruction into a virtual address, which is ultimately converted to a physical address for directly accessing the cache memory 116. It is noted that the virtual address may be sufficient for making an alignment determination (cache line aligned or unaligned) since the applicable lower bits of the virtual address are the same as the physical address (both reference the same-sized page within memory). In one embodiment, for example, a 4 Kbyte page is used in which the lower 12 bits of both the virtual address and the physical address are the same. Once the virtual address is known, and given the data length specified by the load instruction itself, the MOB 114 is able to qualify whether the load instruction is aligned or unaligned. The time point is immediately after the load instruction is dispatched into the MOB 114 from the scheduler 112, for example, during the next clock cycle behind the dispatch of the load instruction, and is much earlier than the time point for the MOB 114 to get the actual physical address to make the aligned or unaligned determination.

If the load is not a cache line unaligned load instruction, then the corresponding physical address for the virtual address is ultimately determined, such as retrieved from a translation look-aside buffer (TLB) or as a result of a table walk process or the like, and the MOB 114 uses the physical address to access the data from a cache line stored in the cache memory 116 (which may ultimately be retrieved from the system memory 118). The result is provided along path 122 to the ROB 120 for storing into the ROB 120 or an allocated PRF and/or forwarding to another execution unit for use by another instruction or the like.

If instead the load is a cache line unaligned load instruction, then the MOB 114 begins processing the load in a similar manner in which it uses the physical address, once determined, to access a portion of the data from a first cache line stored in the cache memory 116. The specified address, however, may be adjusted based on the specified data length. The specified address points to a location within the current cache line and the data length otherwise extends beyond the current cache line to the next sequential cache line. Thus, the current cache line includes only a portion of the target data so that the cache line unaligned load instruction returns only a partial result. The address may be adjusted by a difference between the address of the next sequential cache line and the specified data length as further described herein.

The MOB 114 incorporates reload circuitry 124 that performs additional functions in the event that the load is a cache line unaligned load instruction; the reload circuitry 124 may be considered as part of the MOB 114, or may be separately provided. While the MOB 114 processes the cache line unaligned load instruction with the adjusted address, the reload circuitry 124 may issue a STALL signal to the scheduler 112 to stall or freeze the scheduler 112 from dispatching any related instruction for at least one cycle. In one embodiment, related instructions include another load instruction that will be dispatched by the scheduler 112 from a load queue (not shown) in the scheduler 112 after the unaligned load instruction, and the related instructions may further include any other instructions that depend on the unaligned load instruction. That is, in some embodiments, the wake up/broadcast window is also stalled for at least one cycle to prevent the dispatched unaligned load instruction to wake up the instructions that depend on the unaligned load instruction. Meanwhile, the reload circuitry 124 “increments” the specified load address to the beginning of the next sequential cache line, and “reloads” or re-dispatches the load instruction with the incremented address along path 126 to the front of the MOB 114. As used herein, the term “increment” and its variants as applied to incrementing the address is not intended to mean incremented by one or by any predetermined amount (e.g., byte, cache line, etc.), but instead is intended to mean that the address is increased to the start of the next sequential cache line. In one embodiment, the scheduler 112 is temporarily stalled for one cycle, and the same load instruction with the incremented address and the same data length is dispatched as the very next instruction just behind the original cache line unaligned load instruction.

After the reload circuitry 124 inserts the load instruction with the incremented address at the input of the MOB 114, it then negates the STALL signal to restart the scheduler 112 to resume dispatch operations. It is noted that the stall includes freezing registers and any related paths after load dispatch. In one embodiment, this may be achieved by temporarily setting clock enables to disable to keep the current state of the related registers and related pipeline stages, which means that no more load instruction will be dispatched. In some embodiments, the write back and forwarding of the unaligned load instruction is also stalled by one cycle to further prevent the unaligned load instruction from writing its result back to the PRF or forwarding its result to the source of the instructions that depend on the unaligned load instruction.

Meanwhile, when the data is retrieved from the original cache line unaligned load instruction, rather than providing the result via path 122 to the ROB 120, the MOB 114 to stores the result into a memory 128. In this manner, the memory 128 stores data from the first cache line, shown as LD1, which is partial data since it only includes a portion of the original target data intended by the original load instruction. Meanwhile, the MOB 114 processes the second load instruction with the incremented address and the specified data length, which is the same as the first load instruction except with the incremented address, to retrieve data from the beginning of the next sequential cache line. When the data is retrieved from the second load instruction, the MOB 114 stores the remaining portion of the data, shown as LD2, from the second cache line into the memory 128. LD2 is also partial data since includes only the remaining portion of the original target data. The MOB 114 (or the reload circuitry 124 or the like) then instructs a merge unit 130 within the execute stage 106 to merge LD1 and LD2 into result data. The MOB 114 or the merge unit 130 then provides the merged result data via path 122 for storage in the ROB 120 or in the allocated register of the PRF (and forwarding, if applicable). It is noted that the reload circuitry 124, the memory 128 and the merge unit 130 may all be incorporated within the MOB 114 and may be considered as part of the MOB 114. In such an embodiment, the MOB 114 concurrently executes the STALL and RELOAD operation by itself immediately after it determines that the load is a cache line unaligned load instruction.

FIG. 2 is a simplified diagram illustrating the result of the merge operation performed by the merge unit 130 according to one embodiment of the present invention. The illustration is shown with one type of “endianness” (e.g., big-endian or little-endian), where it is understood that the opposite ordering of bytes is equally contemplated. In this example, the cache line length of the cache memory 116 is 64 bytes (64B) and the unaligned load instruction specifies a data length (DL) of 16 bytes (16B) of data. The original address of the cache line unaligned load instruction, shown as ULA, occurs within a first cache line CL1, in which CL1 only includes the first 5 bytes (5B) of the requested data at the end of the cache line. According to cache line operation, the entire cache line CL1 (at address CL1A) is accessed from or otherwise loaded into the local L1 cache for accessing the requested data. The remaining 11B of the requested data occurs at the beginning of the next cache line CL2.

Since the specified data length DL for the original load instruction is 16 bytes, the unaligned load instruction address ULA may be converted to an adjusted load address ALA by the MOB 114 in order to load 16 bytes from the first cache line CL1 including the 5 byte portion of the target data. In one embodiment, the adjusted load address ALA is determined by replacing the specified address ULA based on a difference between the beginning address of the next sequential cache line and specified data length. As shown, for example, the specified data length is DL, and the address of the next sequential cache line CL2 is shown as CL2A (which is the same as the end of the first cache line CL1), so that ALA=CL2A−DL. The result of execution of the cache line unaligned load instruction with the adjusted address is LD1, which includes first partial data of the original load request.

The incremented load address that is determined by the reload circuitry 124 (or the MOB 114) is the beginning of the next cache line CL2, or CL2A. The second load instruction includes the address CL2A and the originally specified data length DL of 16 bytes, so that it loads the remaining 11 byte portion of the target data along with an additional 5B appended at the end. The result of execution of the second load instruction with the incremented address is LD2, which includes second partial data, or the remaining portion, of the original load request.

As a result of both executions of the cache line unaligned load instruction and the second load instruction as described herein, 16 bytes of the first cache line CL1, shown at 202, is stored as LD1 in the memory 128, and 16 bytes of the second cache line CL2, shown at 204, is stored as LD2 in the memory 128. The results are appended together to combine the first partial data to the second partial data, and the requested 16 byte result portion is isolated and loaded as result data into a result register 206. Various methods may be employed to append the results of both load instructions and merge or isolate the results into the applicable destination register 206, including loading, shifting, masking, inverting, etc., or any combination thereof. It is noted that the first returned one of LD1 and LD2 may be stored into the memory 128, in which the merge unit 130 merges the results when the second one of LD1 and LD2 is returned without necessarily storing into the memory 128.

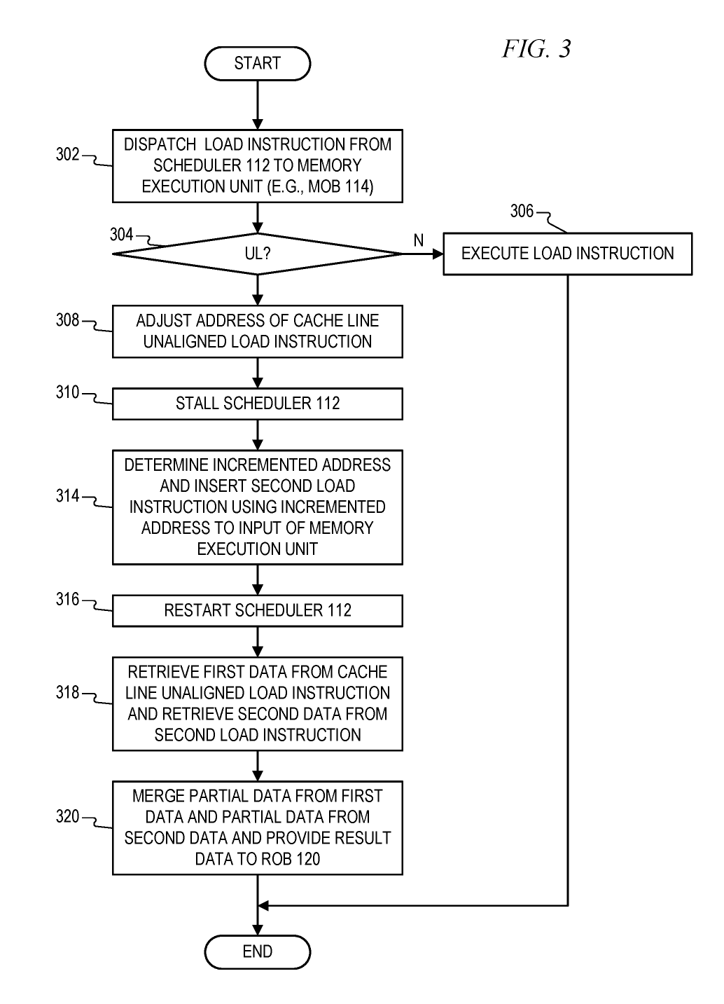

FIG. 3 is a flowchart diagram illustrating stalling pipeline execution by the processor 100 for executing a cache line unaligned load instructions according to an embodiment of the present invention. At block 302, a load instruction is dispatched from the scheduler 112 to the memory execution unit, which is the MOB 114 in the illustrated embodiment. Of course, the scheduler 112 dispatches other instruction types on a continuous or periodic basis during operation of the processor 100. At block 304, the MOB 114 determines whether the load instruction is an unaligned load. If not, then operation proceeds to block 306 in which the MOB 114 executes the load instruction in normal fashion and provides retrieved data to the ROB 120. Operation for the aligned load instruction is completed.

If the MOB 114 determines that the load instruction is an unaligned load at block 304, operation proceeds instead to block 308 in which the MOB 114 adjusts the address of the cache line unaligned load instruction being executed by the MOB 114. The address may be adjusted based on the specified data length of the load instruction along with the beginning address of the next sequential cache line. At next block 310, the MOB 114 stalls the scheduler 112 for at least one clock cycle. Meanwhile, at block 314, the MOB 114 determines an incremented address, such as the beginning address of the next sequential cache line, and inserts a second load instruction at the input of the MOB 114 using the incremented address. It is noted that blocks 310 and 314 could be executed concurrently, that is, the STALL and RELOAD in the illustrated embodiment could be executed in the same clock cycle to ensure that the second load instruction is inserted immediately after the load instruction when the first load instruction is determined to be an unaligned load at block 304. Furthermore, block 308 could be executed concurrently with the step of block 310 or even be executed after block 314 to ensure the priority of the execution of the step of blocks 310 and 314 which inserts the second load instruction. At next block 316, the MOB 114 restarts the scheduler 112 to resume dispatch operations. It is also noted that in some embodiments, if there is no other instruction in the scheduler 112 waiting to be dispatched in the next clock cycle, there is even no need to execute block 310 to stall the scheduler 112. In such a case, the whole pipeline is not delayed at all.

Eventually, at next block 318, first data is retrieved from a first cache line as a result of the execution of the cache line unaligned load instruction, and second data is retrieved from the next sequential cache line as a result of the execution of the second load instruction. At least one or both of the first and second data may be stored in a memory, such as the memory 128. At next block 320, partial data from the first data and partial data from the second data are merged together to provide the original target data as result data provided to the ROB 120.

The foregoing description has been presented to enable one of ordinary skill in the art to make and use the present invention as provided within the context of a particular application and its requirements. Although the present invention has been described in considerable detail with reference to certain preferred versions thereof, other versions and variations are possible and contemplated. Various modifications to the preferred embodiments will be apparent to one skilled in the art, and the general principles defined herein may be applied to other embodiments. For example, the circuits described herein may be implemented in any suitable manner including logic devices or circuitry or the like.

Those skilled in the art should appreciate that they can readily use the disclosed conception and specific embodiments as a basis for designing or modifying other structures for carrying out the same purposes of the present invention without departing from the spirit and scope of the invention. Therefore, the present invention is not intended to be limited to the particular embodiments shown and described herein, but is to be accorded the widest scope consistent with the principles and novel features herein disclosed.

What is claimed is:

1. A processor that is capable of executing cache line unaligned load instructions, comprising:
a scheduler that dispatches a load instruction for execution;
a memory execution unit that executes said load instruction, wherein when said load instruction is determined to be a cache line unaligned load instruction, said memory execution unit stalls said scheduler, determines an incremented address to a next sequential cache line, inserts a copy of said cache line unaligned load instruction as a second load instruction using said incremented address at an input of said memory execution unit, and retrieves first data from a first cache line by executing said cache line unaligned load instruction;
wherein said memory execution unit executes said second load instruction to retrieve second data from said next sequential cache line; and
a merge unit that merges first partial data of said first data with second partial data of said second data to provide result data for said cache line unaligned load instruction.

2. The processor of claim 1, wherein said memory execution unit comprises reload circuitry that stalls said scheduler, determines said incremented address, and inserts said second load instruction.

3. The processor of claim 1, wherein said memory execution unit adjusts a specified address using a specified data length when executing said cache line unaligned load instruction.

4. The processor of claim 3, wherein said memory execution unit adjusts said specified address by a difference between said incremented address and said specified data length, and provides said specified data length with said second load instruction.

5. The processor of claim 1, wherein said merge unit appends said first data to said second data to combine said first partial data with said second partial data into target data, and isolates said target data to provide said result data.

6. The processor of claim 1, wherein:
when said memory execution unit provides said retrieved data to a reorder buffer when said load instruction is not a cache line unaligned load instruction; and
wherein when said load instruction is a cache line unaligned load instruction, said result data from said merge unit is provided to said reorder buffer.

7. The processor of claim 1, wherein said memory execution unit stalls said scheduler for one cycle for inserting said second load instruction at said input of said memory execution unit.

8. The processor of claim 1, wherein said second load instruction is inserted into said memory execution unit immediately after said cache line unaligned load instruction.

9. The processor of claim 1, wherein said memory execution unit stalls said scheduler from dispatching another load instruction and/or any other instructions that depend on said cache line unaligned load instruction.

10. The processor of claim 1, wherein said memory execution unit restarts said scheduler after inserting said second load instruction.

11. A method capable of executing of cache line unaligned load instructions, comprising:
dispatching, by a scheduler, a load instruction for execution;
determining whether the dispatched load instruction is a cache unaligned load instruction during execution; and
when the dispatched load instruction is determined to be a cache unaligned load instruction:
stalling the scheduler that dispatches instructions for execution;
inserting a second load instruction for execution, wherein the second load instruction comprises a copy of the cache unaligned load instruction except using an incremented address to a next sequential cache line;
retrieving first data from a first cache line as a result of executing the cache unaligned load instruction;
retrieving second data from the next sequential cache line as a result of executing the second load instruction; and
merging partial data of the first data with partial data of the second data to provide result data for the cache unaligned load instruction.

12. The method of claim 11, further comprising adjusting an address used with the cache unaligned load instruction based on a specified data length provided with the cache unaligned load instruction and the incremented address.

13. The method of claim 11, wherein said determining whether the dispatched load instruction is a cache unaligned load instruction comprises using a virtual address of the dispatched load instruction.

14. The method of claim 11, wherein said merging comprises:
appending the first data to the second data; and
isolating and combining the first partial data of the first data and the second
partial data of the second data to provide the result data.

15. The method of claim 11, further comprising:
providing retrieved data to a reorder buffer when the dispatched load instruction is not a cache unaligned load instruction; and
providing the result data to the reorder buffer when the dispatched load instruction is a cache unaligned load instruction.

16. The method of claim 11, wherein said inserting the second load instruction comprises inserting the second load instruction as the next load instruction after the cache line unaligned load instruction.

17. The method of claim 11, wherein said stalling the scheduler comprises stalling the scheduler from dispatching another load instruction and/or any instructions that depend on the cache line unaligned load instruction.

18. The method of claim 11, further comprising restarting the scheduler after said inserting a second load instruction.

19. The method of claim 11, further comprising storing at least one of the first and second data before said merging the partial data.

20. The method of claim 11, further comprising:
storing the first data after said retrieving the first data from the first cache line; and
storing the second data after said retrieving the second data from the next sequential cache line.
